(19) United States
(12) Patent Application Publication
(10) Pub. No.: US 2011/0205587 A1
(43) Pub. Date: Aug. 25, 2011

(54) OPERATION PANEL FOR IMAGE PROCESSING APPARATUS AND IMAGE PROCESSING APPARATUS HAVING OPERATION PANEL

(75) Inventors: Toshihisa MOTOSUGI, Aichi-ken (JP); Shin OHBA, Aichi-ken (JP); Jiro GOTO, Aichi-ken (JP); Kana YAMAUCHI, Aichi-ken (JP)

(73) Assignee: Konica Minolta Business Technologies, Inc., Chiyoda-ku (JP)

(21) Appl. No.: 13/030,879

(22) Filed: Feb. 18, 2011

(30) Foreign Application Priority Data
Feb. 22, 2010 (JP) 2010-036709

(51) Int. Cl. G06F 3/02; G06F 3/12

(52) U.S. Cl. 358/1.15; 345/168

(57) ABSTRACT

An operation panel includes: a display that displays a plurality of setting items for use of a function of the image processing apparatus on a screen; an item selection key that allows a user to select from the plurality of items displayed on the screen of the display; and a plurality of value setting keys that allow the user to set a value for the item selected using the item selection key. And the display further displays a first display area that serves to know which one is currently selected among the plurality of items using the item selection key and a second display area that serves to know which one to use to set a value for the item among the plurality of value setting keys.

This application claims priority under 35 U.S.C. §119 to Japanese Patent Application No. 2010-036709 filed on Feb. 22, 2010, the entire disclosure of which is incorporated herein by reference in its entirety.

### BACKGROUND OF THE INVENTION

1. Field of the Invention

The present invention relates to an operation panel for an image processing apparatus such as a copier or printer, and an image processing apparatus having such an operation panel.

2. Description of Related Art

The following description sets forth the inventor's knowledge of related art and problems therein and should not be construed as an admission of knowledge in the prior art.

The image processing apparatuses for large-scale office environments have been developed in terms of multi-functionality and capability, offering high operability for its operation portion having a liquid-crystal display (LCD) with a wide screen, a touch panel and a plurality of hardware keys. On the other hand, minimum essential functions, a smaller operation portion and a very reasonable price are required for the image processing apparatuses for small-scale environments referred to as SOHO (Small Office/Home Office) for example. To meet this requirement, there will be a suggestion to reduce the number of hardware parts, such as hardware keys, and the size of a display, such as a LDC for displaying settings.

However, even when reducing hardware parts and a display in number and size, respectively, only to find operability become poor, since the hierarchy of screens for setting functions will be increasingly complex, and checking settings from one item to another and performing setting will become too troublesome.

As described in Japanese Patent Publication No. 2005-267646, there has been an entry apparatus that is capable of displaying more than one symbol corresponding to more than one key in the same placement as these keys, and displaying symbols corresponding to enabled keys and other symbols corresponding to disabled keys in different visual effects so that users can instantly find target operation keys to achieve their intended operation.

Also as disclosed in Japanese Patent Publication No. 2001-211368, there has been an entry apparatus capable of assigning more than one function to one operation key and using it as a multifunctional key that switches between functions depending on circumstances. This entry apparatus displays the functions of the operation key on a key function display and what is entered via the operation key on a setting check display, then changes what is displayed on the setting check display in response to an operation when the operation is performed via the operation key, which is described in this patent publication. And a screen displaying optional items and other information can be non-cyclically scrolled backward and forward with a motion of a cursor, and when it comes to the motion end (end of the screen pane), a notice is displayed on the key function display so that users can know that it cannot be scrolled any forward, which is further described in this patent publication.

However, with use of the technologies in Japanese Patent Publications No. 2005-267646 and No. 2001-211368, users can instantly find target operation keys to achieve their intended operation and know a motion limit of a cursor or etc. However, these do not bring a complete solution to address the problem that when a display is reduced in size, it is troublesome to check settings from one item to another.

The description herein of advantages and disadvantages of various features, embodiments, methods, and apparatus disclosed in other publications is in no way intended to limit the present invention. Indeed, certain features of the invention may be capable of overcoming certain disadvantages, while still retaining some or all of the features, embodiments, methods, and apparatus disclosed therein.

### SUMMARY OF THE INVENTION

The preferred embodiments of the present invention have been developed in view of the above-mentioned and/or other problems in the related art. The Preferred embodiments of the present invention can significantly improve upon existing methods and/or apparatuses.

It is an object of the present invention to provide an operation panel for an image processing apparatus, capable of allowing users to check settings from one item to another and perform setting without trouble, by eliminating the poorness of operability, when a display is reduced in size.

It is another object of the present invention to provide an image processing apparatus having an operation panel, capable of allowing users to check settings from one item to another and perform setting without trouble, by eliminating the poorness of operability, when a display is reduced in size.

According to a first aspect of the present invention, an operation panel for an image processing apparatus includes:

a display that displays a plurality of setting items for use of a function of the image processing apparatus on a screen;

an item selection key that allows a user to select from the plurality of items displayed on the screen of the display; and

a plurality of value setting keys that allow the user to set a value for the item selected using the item selection key, and

wherein the display further displays on the screen, a first display area that serves to know which one is currently selected among the plurality of items using the item selection key, and a second display area that serves to know which one to use to set a value for the item among the plurality of value setting keys.

According to a second aspect of the present invention, an image processing apparatus includes:

an operation panel including:
a display that displays a plurality of setting items for use of a function of the image processing apparatus on a screen;
an item selection key that allows a user to select from the plurality of items displayed on the screen of the display; and
a plurality of value setting keys that allow the user to set a value for the item selected using the item selection key, and

a controller that makes the display further display a first display area that serves to know which one is currently selected among the plurality of items using the item selection key and a second display area that serves to know which one to use to set a value for the item among the plurality of value setting keys.

The above and/or other aspects, features and/or advantages of various embodiments will be further appreciated in view of the following description in conjunction with the accompanying figures. Various embodiments can include and/or exclude different aspects, features and/or advantages where applicable. In addition, various embodiments can combine one or more aspect or feature of other embodiments where applicable. The descriptions of aspects, features and/or advantages of particular embodiments should not be construed as limiting other embodiments or the claims.

### BRIEF DESCRIPTION OF THE DRAWINGS

The preferred embodiments of the present invention are shown by way of example, and not limitation, in the accompanying figures, in which:

FIG. 1 is a perspective view externally showing an image forming apparatus according to one embodiment of the present invention;

FIG. 2 is a block diagram showing a configuration of the image forming apparatus of FIG. 1;

FIG. 3 is a plain view of an operation panel;

FIG. 4 is a plain view showing what happens to the operation panel when the value set for Paper Feed Tray is changed;

FIG. 5 is a plain view showing what happens to the operation panel when Paper Size is selected by pressing an item selection key;

FIG. 6 is a plain view showing what happens to the operation panel when Reduce/Enlarge is selected by pressing an item selection key;

FIG. 7 is a plain view showing what happens to the operation panel when Original Quality is selected by pressing an item selection key;

FIG. 8 is a plain view showing what happens to the operation panel when Tone is selected by pressing an item selection key;

FIG. 9 is a plain view showing what happens to the operation panel when Paper Size is selected by pressing an item selection key;

FIG. 10 is a plain view showing what happens to the operation panel when the value set for Tone is changed;

FIG. 11 is a plain view showing what happens to the operation panel when the value set for Tone, which is changed in FIG. 10, is further changed;

FIG. 12 is a plain view showing what happens to the operation panel when Number of Copies is selected by pressing an item selection key;

FIG. 13 is a plain view showing what happens to the operation panel when the value set for Number of Copies is changed after Number of Copies is selected; and

FIG. 14 is a plain view showing what happens to the operation panel when the value set for Number of Copies is changed to the maximum one after Number of Copies is selected.

### DETAILED DESCRIPTION OF THE PREFERRED EMBODIMENTS

In the following paragraphs, some preferred embodiments of the invention will be described by way of example and not limitation. It should be understood based on this disclosure that various other modifications can be made by those in the art based on these illustrated embodiments.

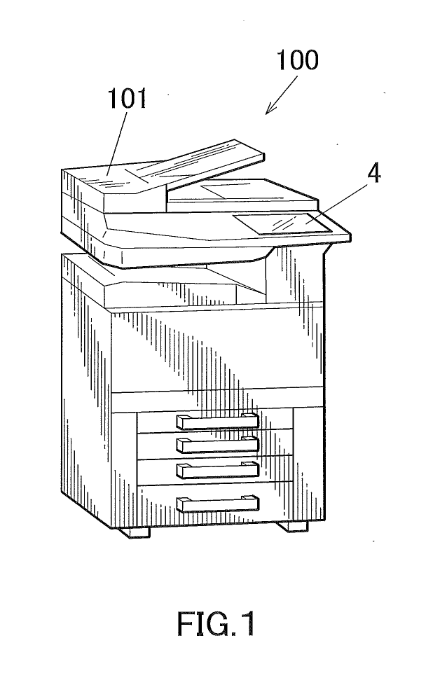

FIG. 1 is a perspective view showing an image forming apparatus 100 that is employed as an image processing apparatus according to one embodiment of the present invention.

In this embodiment, this image forming apparatus 100 is a multifunctional machine having more than one function installed therein such as the copy function, the print function and the facsimile function. It has an operation panel 4 mounted on the front of the top surface of a main body 101 and performs operations according to user instructions given via the operation panel 4.

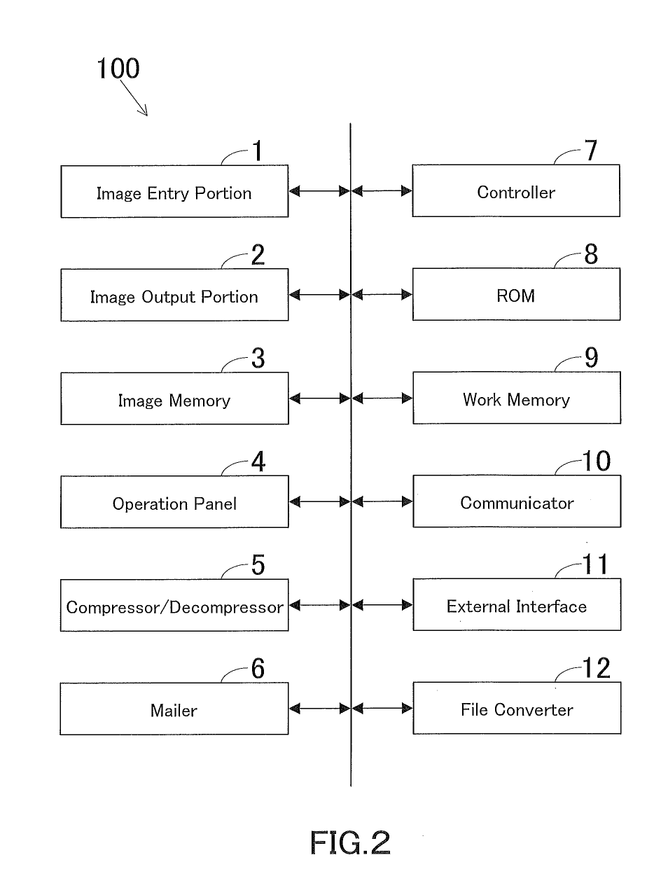

FIG. 2 is a block diagram showing a configuration to control the image forming apparatus 10.

The image forming apparatus 100 includes an image entry portion 1, an image output portion 2, an image memory 3, an operation panel 4, a compressor/decompressor 5, a mailer 6, a controller 7, a ROM 8, a work memory 9, a communicator 10, an external interface 11 and a file converter 12.

The image entry portion 1 includes an image sensor such as a CCD, a slider controller and various image processing controllers. It optically reads a document to convert it into image data that is an electrical signal.

The image output portion 2 prints out image data and etc. entered by the image entry portion 1 and received from outside via the communicator 10, on predetermined type of paper. It includes an engine that performs printing, an engine controller that controls the engine and various image processing controllers.

The image memory 3 stores image data entered by the image entry portion 1 and received via the communicator 10 and the external interface 11.

The operation panel 4 is a user interface that includes a hardware keyboard carrying hardware keys and a display such as a liquid crystal display (LDC). It allows users to perform setting to use a function of the image forming apparatus 100 and displays settings and other information on the display. The operation panel 4 will be described in details later on.

The compressor/decompressor 5 compresses entered image data and decompresses compressed image data according to need.

The mailer 6 is an application program that transmits and receives e-mails.

The controller 7 includes a CPU and peripheral circuit not illustrated in any Figures. It centrally controls all the operations in the image forming apparatus 100, including an operation to control the display of the operation panel 4. For example, the controller 7 performs a predetermined operation according to an operation program stored in advance on the ROM 8, in response to an operation signal corresponding to a user instruction given via the operation panel 4.

The ROM 8 stores an operation program, data for control and etc. for the CPU of the controller 7, and the work memory 9 temporarily stores control variables. The work memory 9 and the image memory 3 are consolidated into a volatile memory.

The communicator 10 exchanges image information and etc. with communication apparatuses, by connecting to a communication path such as a telephone circuit via a modem or a NCU (Network Control Unit) or a network via a LAN (Local Area Network) controller that is not illustrated in Figures.

The external interface 11 serves to connect to external apparatuses, and the file converter 12 converts files into other file formats such as those for image data, e-mails and etc.

The operation panel 4 will be described hereinafter.

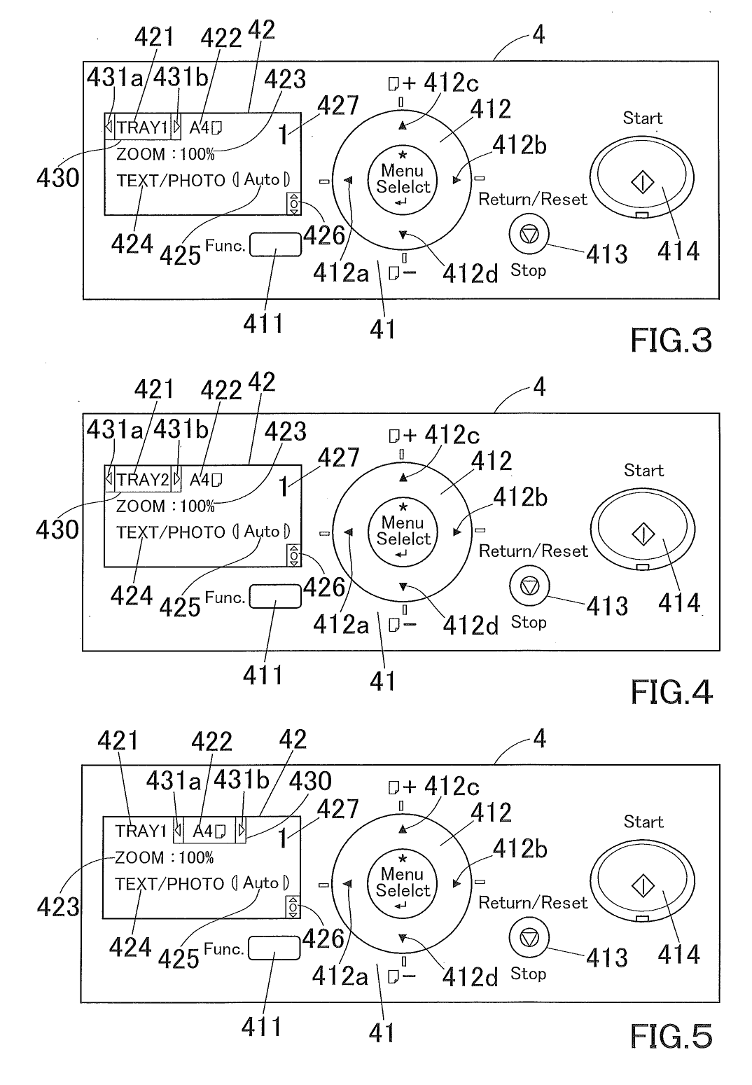

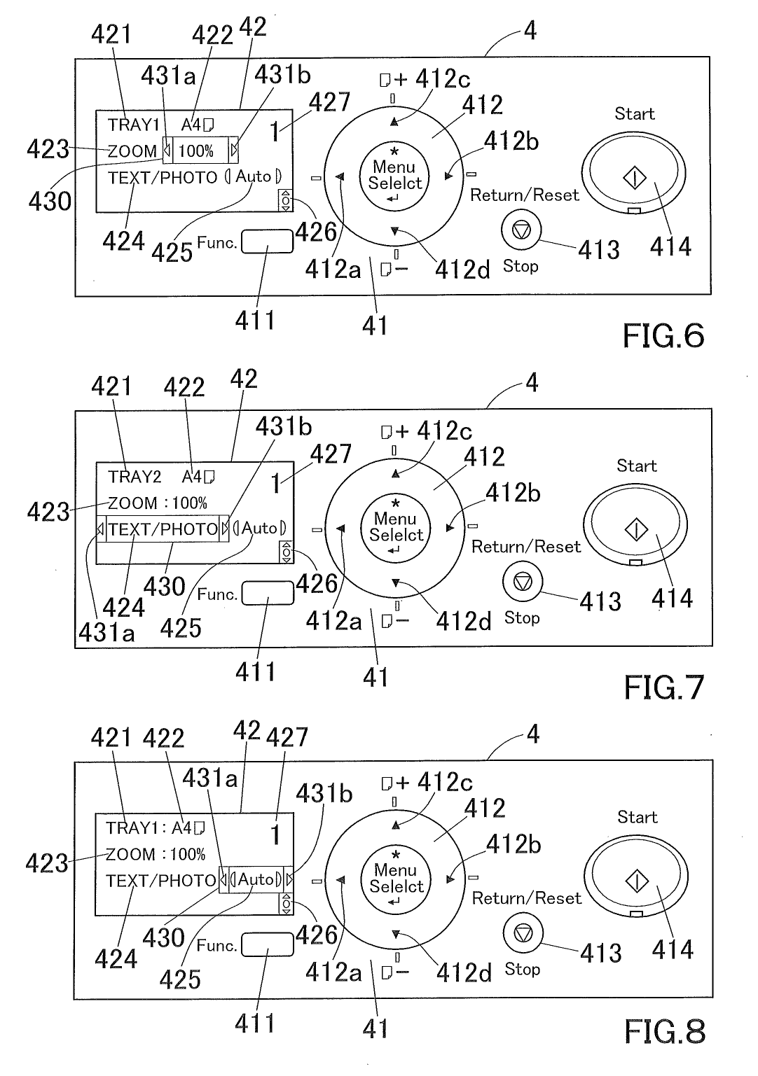

FIG. 3 is a plain view of the operation panel 4.

The operation panel 4 includes a hardware keyboard 41 carrying a plurality of hardware keys and a display 42 that is a compact LCD.

The hardware keys include, in this embodiment, an item selection key 411 positioned below the display 42; a multi-operation key 412 positioned in the upper right of the item selection key 411; a stop key 413 positioned in the lower right of the multi-operation key 412; and a start key 414 positioned in the upper right of the stop key 413.

The item selection key 411 is pressed by users when trying to use a predetermined function of the image forming apparatus 100, for example the copy function, for the purpose of setting values and selecting Paper Feed Tray, Paper Size, Reduce/Enlarge, Original Quality, Tone or etc. to change a set value.

The multi-operation key 412 has more than one value setting key to set a value and change a value set for an item selected by pressing the item selection key 411, in different positions thereon provided in the horizontal and vertical directions. That is, the multi-operation key 412 has four value setting keys (hereinafter also referred to as “arrow keys”) that are arrow keys 412a, 412b, 412c and 412d positioned in the left, right, upper and lower ends thereof, with left-pointing, right-pointing, up-pointing and down-pointing arrow-heads (also referred to as “triangles”), all black-out, provided thereon, respectively. With pressing of these arrow keys with such triangles being on them, switching operations are performed. Meanwhile, with pressing of a central region of the multi-operation key 412, a screen with a lower-layer mode menu is called out and a mode can be selected from such a menu. The stop key 413 causes the image forming apparatus 100 to stop operating. Furthermore, in this embodiment, it is also used as a key to return to the previous screen and reset the current mode.

The start key 414 causes the image forming apparatus 100 to start operating.

The display 42 displays more than one item to use the copy function. More particularly, in this embodiment, it displays only the current values set for Paper Feed Tray 421, Paper Size 422, Reduce/Enlarge 423, Original Quality 424 and Tone 425, or alternatively displays these items together with the current values set for them.

For example, “TRAY-1” is displayed for Paper Feed Tray 421, which means that the paper feed tray of No. 1 is currently applied to the copy function.

“A4□” is displayed for Paper Size 422, which means that the A4-size paper with portrait orientation is currently applied to the copy function.

“ZOOM: 100%” is displayed for Reduce/Enlarge 423, which means that a copy of a document will be made at a rate of 100% i.e. without reduction/enlargement in size.

“TEXT/PHOTO”, indicating a type of an original document is displayed for Original Quality 424, which means that the mode for making a copy of a document with both texts and photos is currently applied to the copy function. In addition to “TEXT/PHOTO”, there are “TEXT” indicating a document with texts only and “PHOTO” indicating a document with photos only that can be set for Original Quality.

“AUTO”, accompanied with semicircles on both sides is displayed for Tone 425, which means that the mode for automatic tone adjustment is currently applied to the copy function.

As described above, the current values set for the items are properly displayed, which allows users to know the information quite easily.

To change a set value, it is necessary for users to select a target item by pressing the item selection key 411. More particularly in this embodiment, the value set for the currently selected item 421 is captured in a pane as a first display area (also referred to as “display pane”) 430 on the display, as illustrated in FIG. 3. And finding the value set for the item 421 captured in the pane 430 on the display, users can know that the item 421 is currently selected using the item selection key 411. As for the items 421 through 425, the next item is selected with each pressing of the item selection key 411, according to which the value set for the item is captured in the pane 430. As described above, users can instantly understand that the item 421 is currently selected by pressing the item selection key 411 and can easily arrive at a target item to change a set value by repeatedly pressing the item selection key 411.

White-out triangle icons 431a and 431b are provided in second panes positioned at both right and left ends of the display pane 430, just inside or outside thereof. The icons 431a and 431b correspond to the arrow keys 412a and 412b, respectively. Hereinafter, these icons corresponding to the arrow keys will be also referred to as “arrow icons”.

The left-pointing and right-pointing arrow icons 431a and 431b give a good hint which ones to use from the left-pointing, right-pointing, up-pointing and down-pointing arrow keys 412a, 412b, 412c and 412d of the multi-operation key 412 to change the value set for the item 421. Particularly, the left-pointing and right-pointing arrow icons 431a and 431b, which look exactly the same as the triangles put on the left-pointing and right-pointing arrow keys 412a and 412b for their shapes, orientations and positions, are displayed at the left and right ends of the pane 430, respectively. The left-pointing arrow icon 431a at the left end corresponds to the left-pointing arrow key 412a of the multi-operation key 412, meanwhile the right-pointing arrow icon 431b at the right end corresponds to the right-pointing arrow key 412b of the multi-operation key 412, which demonstrates that it is necessary to use the left-pointing arrow key 412a and/or the right-pointing arrow key 412b of the multi-operation key 412, in order to change the value set for the item 421, currently captured in the pane 430.

As described above, the left-pointing and right-pointing arrow icons 431a and 431b, which look exactly the same as the triangles put on the left-pointing and right-pointing arrow keys 412a and 412b for their shapes, orientations and positions are displayed, respectively, and this gives a good hint. Therefore, users can instantly understand which ones to use from the plurality of keys, the arrow keys 412a, 412b, 412c and 412c of the multi-operation key 412 to change the current value set for the item 421. Using the left and right-pointing arrow keys 412a and 412b, as if these were the left-pointing and right-pointing arrow icons 431a and 431b in the second panes, users can immediately change the set value.

In the lower right area of the screen of the display 42, there is an icon 416 corresponding to the multi-operation key 412 and the up-pointing and down-pointing arrow keys 412c and 412d, collectively, which demonstrates that the multi-operation key 412 and the up-pointing and down-pointing arrow keys 412c and 412d serve to perform a certain operation. When it falls into an inoperable status, this icon 426 is hidden. In this embodiment, with pressing of the up-pointing arrow key 412c of the multi-operation key 412 while the icon 426 is displayed, the number displayed for Number of Copies (“1” is set for this item in FIG. 3) in the upper right area of the screen of the display 42 goes up, meanwhile with pressing of the down-pointing arrow key 412d of the multi-operation key 412 while the icon 426 is displayed, the number goes down. Furthermore, with pressing of a central region of the multi-operation key 412, a screen with a menu for detail settings of the function is called out, or a screen with a lower-layer mode menu is called out and a mode can be selected from such a menu.

Hereinafter, how users set or change values for the items 421 through 425 and screens displayed on the display 42 at that time will be described.

As illustrated in FIG. 3, Paper Feed Tray 421 is currently selected. And when a user presses the left-pointing arrow key 412a or the right-pointing arrow key 412b of the multi-operation key 412, a different paper feed tray will be employed, as illustrated in FIG. 4.

When the user presses the item selection key 411 while Paper Feed Tray 421 is selected as illustrated in FIG. 3, the value set for Paper Size 422 will be captured in the display pane 430 including the left-pointing and right-pointing arrow icons 431a and 431b. This is what is illustrated in FIG. 5. And when pressing the item selection key 411 once more, the value set for Reduce/Enlarge 423 will be captured in the display pane 430 including the arrow icons 431a and 431b. Subsequently, when pressing the key once more, the value set for Original Quality 424 (FIG. 7) will be captured, and when further pressing it once more, the value set for Tone 425 (FIG. 8) will be captured, and then when still further pressing it once more, the value set for Paper Feed Tray 421 will be captured again as illustrated in FIG. 3. In this way, the values set for the items 421 to 425 will be cyclically displayed in the display pane 430, one by one.

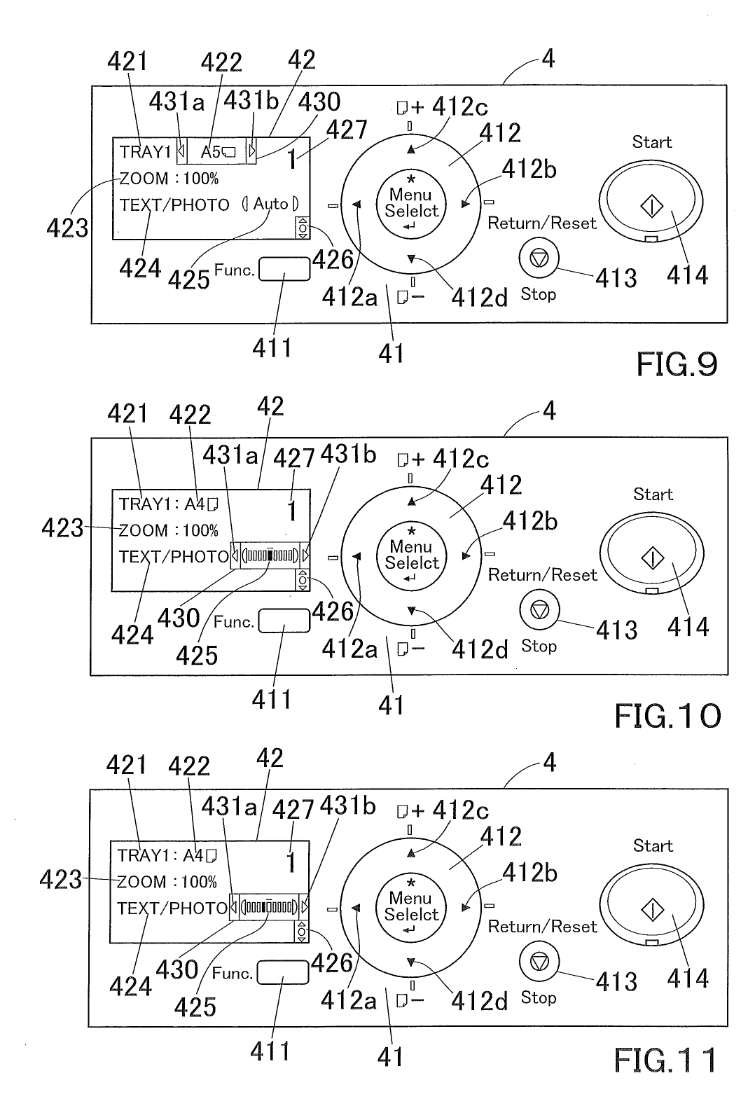

When pressing the left-pointing arrow key 412a or the right-pointing arrow key 412b of the multi-operation key 412 while the value set for Paper Size 422 is captured in the display pane 430 as illustrated in FIG. 5, the paper size of paper in the paper feed tray 1 will be changed as illustrated in FIG. 9. FIG. 9 is a view showing when the set value is switched from the A4-size paper with portrait orientation to A5-size with landscape orientation, by pressing the right-pointing arrow key 412b.

Hereinafter, what happens when pressing the right-pointing arrow key 412b of the multi-operation key 412 while Tone 425 is selected as illustrated in FIG. 8, will be described. When pressing the key one time, the set value will be switched from automatic tone adjustment to manual tone adjustment as illustrated in FIG. 10. When pressing the left-pointing arrow key 412a while it is manual tone adjustment, the parameter will be changed and the pointer will be moved to the left in the parameter indicator. That is, the tone can be turned lighter. To move the pointer more to the right in the parameter indicator, it is necessary to repeatedly press the left-pointing arrow key 412a.

When pressing the right-pointing arrow key 412b while the pointer is there as in FIG. 11, the pointer will be back to the center in the parameter indicator, and when further pressing the right-pointing arrow key 412b, it will be back to automatic tone adjustment as illustrated in FIG. 8. To move the pointer to the right in the parameter indicator, in other words, to turn the tone darker, it is necessary to press the right-pointing arrow key 412b one time while Tone is selected as illustrated in FIG. 8, which causes it to switch from automatic to manual tone adjustment, and then repeatedly press the right-pointing arrow key 412b as many times as need.

To change the values set for the other items, it is also necessary to use the left-pointing arrow key 412a and/or the right-pointing arrow key 412b.

As described above, in this embodiment, with the existence of the arrow icons 431a and 431b displayed at both right and left ends of the display pane 430 in which a value set for one of the items 421 to 425 is currently captured by pressing the item selection key 411, the screen of the display 42 and hardware keys that are the item selection key 411 and the arrow keys 412a to 412d, can be interrelated. Accordingly, the display 42 and the hardware keys can be reduced in size and number, respectively, without losing the good operability of the operation panel in setting values for the items 421 to 425 and checking set values from one item to another. As a result, now the operation panel 4 with compactness, low cost and good operability can be obtained.

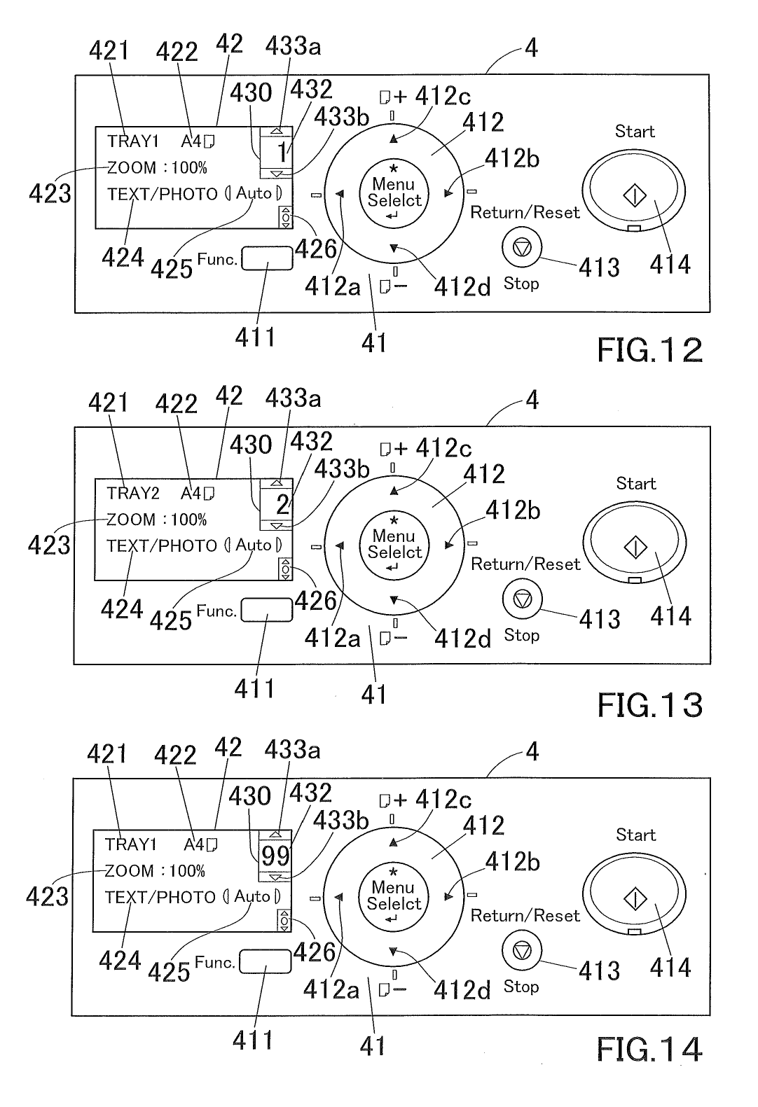

FIGS. 12 through 14 are views of the operation panel 4 according to another embodiment of the present invention.

In this embodiment, as well as Paper Feed Tray, Paper Size, Reduce/Enlarge, Original Quality and Tone, Number of Copies, which set value is displayed at the upper right corner of the display 42 (“1” is set in FIG. 12, meaning that one copy will be made), can be selected by pressing the item selection key 411. Therefore, the user presses the item selection key 411 as many times as need to arrive at Number of Copies 432. Particularly, when pressing the item selection key 411 while Tone 425 is selected as illustrated in FIG. 8, Number of Copies 432 will be selected.

In the present state of things, the value set for Number of Copies 432, which is “1” here, is captured in the display pane 430, and at the same time, the up-pointing arrow icon 433a and the down-pointing arrow icon 433b, which look exactly the same as the triangles put on the up-pointing and down-pointing arrow keys 412c and 412d for their shapes, orientations and positions, are displayed at the upper and lower ends of the display pane 430, respectively. The up-pointing arrow icon 433a corresponds to the up-pointing arrow key 412c of the multi-operation key 412, meanwhile the down-pointing arrow icon 433b corresponds to the down-pointing arrow key 412d of the multi-operation key 412, which demonstrates that it is necessary to use the up-pointing arrow key 412c and/or the down-pointing arrow key 412d of the multi-operation key 412, in order to change the value set for Number of Copies.

In this embodiment, when pressing of the up-pointing arrow 412c, the number displayed for Number of Copies goes up to “2” as illustrated in FIG. 13. FIG. 14 is a view showing “99”, which is the maximum value that can be set for the item, having been reached by continuously pressing the up-pointing arrow key 412c. “99”, as illustrated in FIG. 14, may be reached by pressing the down-pointing arrow key 412d while “1” is displayed for Number of Copies as illustrated in FIG. 12.

As described above, the up-pointing and down-pointing arrow icons 433a and 433b, which look exactly the same as the triangles put on the up-pointing and down-pointing arrow keys 412c and 412d for their shapes, orientations and positions are displayed, respectively, and this gives a good hint. Therefore, users can instantly understand which ones to use from the plurality of keys, the arrow keys 412a, 412b, 412c and 412c, and rapidly change the value set for Number of Copies using the up-pointing and down-pointing arrow keys 412c and 412d as if these were the up-pointing and down-pointing arrow icons 433a and 433b displayed on the display.

In this embodiment described above, a setting screen for use of the copy function is displayed on the display 42 for example, however, setting screens for use of other functions such as the facsimile function and the scan-to-network function may be displayed thereon. And the setting screens for use of the plurality of functions may be switched from one to another by pressing a central region of the multi-operation key 412. Furthermore, in this embodiment, the image processing apparatus is a multifunctional machine for example, however, as a matter of course, this embodiment may be applied to a simple copier and a simple facsimile.

And the left-pointing, right-pointing, up-pointing and down-pointing arrow keys 412a, 412b, 412c and 412d are collectively provided onto the multi-operation key 412, however, those keys may be independently provided.

And the arrow icons, which look exactly the same as the triangles put on the left-pointing, right-pointing, up-pointing and down-pointing arrow keys 412a, 412b, 412c and 412d for their shapes, orientations and positions are displayed, which makes the arrow icons and the arrow keys connected to each other. However, the arrow icons may look exactly the same as the triangles for their shapes and orientations only, or alternatively, for their positions only. Meanwhile, the elements to recognize the similarity are not limited to shape, orientation and position, and it is necessary to display icons and etc. in a manner that allows users to understand which ones to use from the plurality of value setting keys to achieve their intended operation.

While the present invention may be embodied in many different forms, a number of illustrative embodiments are described herein with the understanding that the present disclosure is to be considered as providing examples of the principles of the invention and such examples are not intended to limit the invention to preferred embodiments described herein and/or illustrated herein.

While illustrative embodiments of the invention have been described herein, the present invention is not limited to the various preferred embodiments described herein, but includes any and all embodiments having equivalent elements, modifications, omissions, combinations (e.g. of aspects across various embodiments), adaptations and/or alterations as would be appreciated by those in the art based on the present disclosure. The limitations in the claims are to be interpreted broadly based on the language employed in the claims and not limited to examples described in the present specification or during the prosecution of the application, which examples are to be construed as non-exclusive. For example, in the present disclosure, the term “preferably” is non-exclusive and means “preferably, but not limited to”. In this disclosure and during the prosecution of this application, means-plus-function or step-plus-function limitations will only be employed where for a specific claim limitation all of the following conditions are present In that limitation: a) “means for” or “step for” is expressly recited; b) a corresponding function is expressly recited; and c) structure, material or acts that support that structure are not recited. In this disclosure and during the prosecution of this application, the terminology “present invention” or “invention” may be used as a reference to one or more aspect within the present disclosure. The language present invention or invention should not be improperly interpreted as an identification of criticality, should not be improperly interpreted as applying across all aspects or embodiments (i.e., it should be understood that the present invention has a number of aspects and embodiments), and should not be improperly interpreted as limiting the scope of the application or claims. In this disclosure and during the prosecution of this application, the terminology “embodiment” can be used to describe any aspect, feature, process or step, any combination thereof, and/or any portion thereof, etc. In some examples, various embodiments may include overlapping features. In this disclosure and during the prosecution of this case, the following abbreviated terminology may be employed: “e.g.” which means “for example”, and “NB” which means “note well”.

What is claimed is:

1. An operation panel for an image processing apparatus comprising:
a display that displays a plurality of setting items for use of a function of the image processing apparatus on a screen;
an item selection key that allows a user to select from the plurality of items displayed on the screen of the display; and
a plurality of value setting keys that allow the user to set a value for the item selected using the item selection key, and
wherein the display further displays on the screen, a first display area that serves to know which one is currently selected among the plurality of items using the item selection key, and a second display area that serves to know which one to use to set a value for the item among the plurality of value setting keys.

2. The operation panel recited in claim 1, wherein the first display area is positioned in the vicinity of the currently selected item, and everytime one of the items is selected using the item selection key, the first display area jumps to a predetermined position for the item.

3. The operation panel recited in claim 1, wherein the current value set for the item is shown.

4. The operation panel recited in claim 1, wherein the value setting keys have different symbols being thereon, and the second display area shows these symbols to facilitate a value setting operation.

5. The operation panel recited in claim 1, wherein the second display area shows how the value setting keys to set values are positioned.

6. The operation panel recited in claim 5, wherein the value setting keys to set values are provided in different positions in the horizontal direction, and the second display area is positioned at both right and left ends of the first display area so as to suggest that the value setting keys provided in the horizontal direction could serve.

7. The operation panel recited in claim 5, wherein the value setting keys to set values are provided in different positions in the vertical direction, and the second display area is positioned at both upper and lower ends of the first display area so as to suggest that the value setting keys provided in the vertical direction could serve.

8. The operation panel recited in claim 1, wherein the first display area corresponds to a pane capturing the value set for the currently selected item, and the second display area is positioned just inside or outside of the pane.

9. An image processing apparatus comprising:
an operation panel comprising:
a display that displays a plurality of setting items for use of a function of the image processing apparatus on a screen;
an item selection key that allows a user to select from the plurality of items displayed on the screen of the display; and
a plurality of value setting keys that allow the user to set a value for the item selected using the item selection key, and
a controller that makes the display further display a first display area that serves to know which one is currently selected among the plurality of items using the item selection key and a second display area that serves to know which one to use to set a value for the item among the plurality of value setting keys.

10. The image processing apparatus recited in claim 9, wherein the controller makes the first display area position in the vicinity of the currently selected item, and everytime one of the items is selected using the item selection key, it also makes the first display area jump to a predetermined position for the item.

11. The image processing apparatus in claim 9, wherein the controller makes the current value set for the item shown.

12. The image processing apparatus recited in claim 9, wherein the value setting keys have different symbols being thereon, and the controller makes the second display area show these symbols to facilitate a value setting operation.

13. The image processing apparatus recited in claim 9, wherein the controller makes the second display area show how the value setting keys to set values are positioned.

14. The image processing apparatus recited in claim 13, wherein the value setting keys to set values are provided in different positions in the horizontal direction, and the controller makes the second display area position at both right and left ends of the first display area so as to suggest that the value setting keys provided in the horizontal direction could serve.

15. The image processing apparatus recited in claim 13, wherein the value setting keys to set values are provided in different positions in the vertical direction, and the controller makes the second display area position at both upper and lower ends of the first display area so as to suggest that the value setting keys provided in the vertical direction could serve.

16. The image processing apparatus recited in claim 9, wherein the controller makes the first display area correspond to a pane capturing the value set for the currently selected item, and also makes the second display area position just inside or outside of the pane.
